(19) United States
(12) Patent Application Publication
(10) Pub. No.: US 2014/0047360 A1
(43) Pub. Date: Feb. 13, 2014

(54) BACKGROUND APPLICATION PAGE ARCHITECTURE FOR WEB APPLICATIONS

(71) Applicants: Erik Kay, Belmont, CA (US); Mihai Parparita, Mountain View, CA (US); Dimitri Glazkov, Mountain View, CA (US)

(72) Inventors: Erik Kay, Belmont, CA (US); Mihai Parparita, Mountain View, CA (US); Dimitri Glazkov, Mountain View, CA (US)

(73) Assignee: GOOGLE INC., Mountain View, CA (US)

(21) Appl. No.: 13/570,951

(22) Filed: Aug. 9, 2012

(51) Int. Cl. G06F 3/01

(52) U.S. Cl. 715/760

(57) ABSTRACT

A runtime environment is provided, which is capable of executing a background application page that persists over a lifetime of a web application. The background application page does not have its own user interface, and the background application page is launched after a web browser is launched. Using a processor of a computing device, the background application page is notified upon receiving an event related to the web application. The background application page is employed to control at least one user interface for an activity page of the web application.

### TECHNICAL FIELD

This description generally relates to background application pages that allow a web application to persist and operate in the background of a system, without a visible user interface.

### BACKGROUND

If a main page for an application is closed, other windows may stop functioning. For example, if someone accidentally closes a main tab for a web application (such as an email web application), all tabs or windows may stop executing as well (such as a compose mail window). A similar problem exists for applications that operate as native applications but are coded as web applications.

Additionally, notifications typically do not appear after all visible windows for an application are closed. For example, a hosted web application starts executing when a user visits a page in the web application or clicks the web application's icon in a web browser's New Tab page. When the user closes all tabs for that web application, the web application stops executing. Notifications related to the web application may not be displayed unless the user opens the web application again. Accordingly, there exists a need for systems and methods to address the shortfalls of present technology and to provide other new and innovative features.

### SUMMARY

According to one general aspect, a method for background application page implementation includes providing a runtime environment capable of executing a background application page that persists over a lifetime of a web application. The background application page does not have its own user interface, and the background application page is launched after a web browser is launched. Using a processor of a computing device, the background application page is notified upon receiving an event related to the web application. The background application page is employed to control at least one user interface for an activity page of the web application.

According to another general aspect, a system includes a memory and a microprocessor operably connected to the memory and configured to execute code to provide a runtime environment capable of executing a background application page that persists over a lifetime of a web application. The background application page does not have its own user interface, the background application page persists after all user interfaces for the web application are closed, and the background application page is launched after a web browser is launched. The background application page is notified upon receiving an event related to the web application. The background application page is employed to control multiple user interfaces for activity pages of the web application.

According to yet another general aspect, a non-transitory computer readable medium may contain executable code that causes a computing device to provide a runtime environment capable of executing a background application page that persists over a lifetime of a web application. The background application page does not have its own user interface. The background application page persists after all user interfaces for the web application are closed, and the background application page is launched after a web browser is launched. Using a processor of the computing device, the background application page may be notified upon receiving an event related to the web application. The background application page may be employed to control multiple user interfaces for activity pages of the web application.

The details of one or more implementations are set forth in the accompanying drawings and the description below. Other features will be apparent from the description and drawings, and from the claims.

### BRIEF DESCRIPTION OF THE DRAWINGS

FIG. 1A is an example block diagram of a web application.

FIG. 1B is an example block diagram of a web application including a background application page architecture, in accordance with systems and methods described here.

FIG. 2 is a block diagram of an application that implements a multi-process architecture in accordance with systems and methods described here.

FIG. 3 is a schematic of an example system configured to provide background application pages for applications, in accordance with systems and methods described here.

FIG. 4 is a flow diagram illustrating an application lifecycle, in accordance with systems and methods described here.

FIG. 5 is a flow diagram illustrating unloading a background application page, in accordance with systems and methods described here.

FIG. 6 is a flow diagram illustrating example operations of the system of FIGS. 1B-5.

FIG. 7 is a block diagram showing example or representative computing devices and associated elements that may be used to implement systems and methods in accordance with FIGS. 1B-6.

Like reference symbols in the various drawings indicate like elements.

### DETAILED DESCRIPTION

A hosted web application may start executing when a user visits a page in the web application or clicks the web application's icon in a browser's New Tab page. When the user closes all tabs for that web application, the web application may stop executing. The same situation may occur with other applications, such as native applications, or natively operating applications.

A new “background” application page feature changes this process. Background application pages are implemented as the central point for how an application, such as a web application, works. The background application page becomes the hub of handling all system level events, including events such as launch events, notifications, downloading data from a server, uploading data to a server, preparing a user interface (UI), playing audio, performing computations, etc. The background application page has no UI of its own, and therefore operates independently of what a user sees, but the background application page may operate in the same process as its web application.

Another use of the background application page is to receive and display notifications, such as server push notifications, for events that may occur when a web application's UI is not visible—for example, a notification about a new email message, a new chat message, a bit of news, or a price change of a stock or an item in an online store. The background application page may receive events such as push notifications from a remote server. Applications with the background application page can use the background application page to do miscellaneous tasks in an invisible page that can live as long as the browser runs, or as long as a user session on a runtime environment runs.

The background application page may operate by controlling the application lifetime and the UI of the application, so that if one window (e.g., an email program's main window) closes, another window related to the application (e.g., a separate compose e-mail window) may remain open and functioning. The point of control logic is run by the background application page. The background application page may let a hosted web application (or, as other examples, a packaged web application, or web browser extension) run as soon as a user logs into their computer—before the user launches the browser or the web application—and to continue running even when the browser or the web application has no visible windows. In some implementations, if the user explicitly quits the browser (for example, by logging out of the browser), the browser and web application (including the background application page) may both exit. The developer can put any code for a web application into the background application page (e.g., by putting the code into an HTML file).

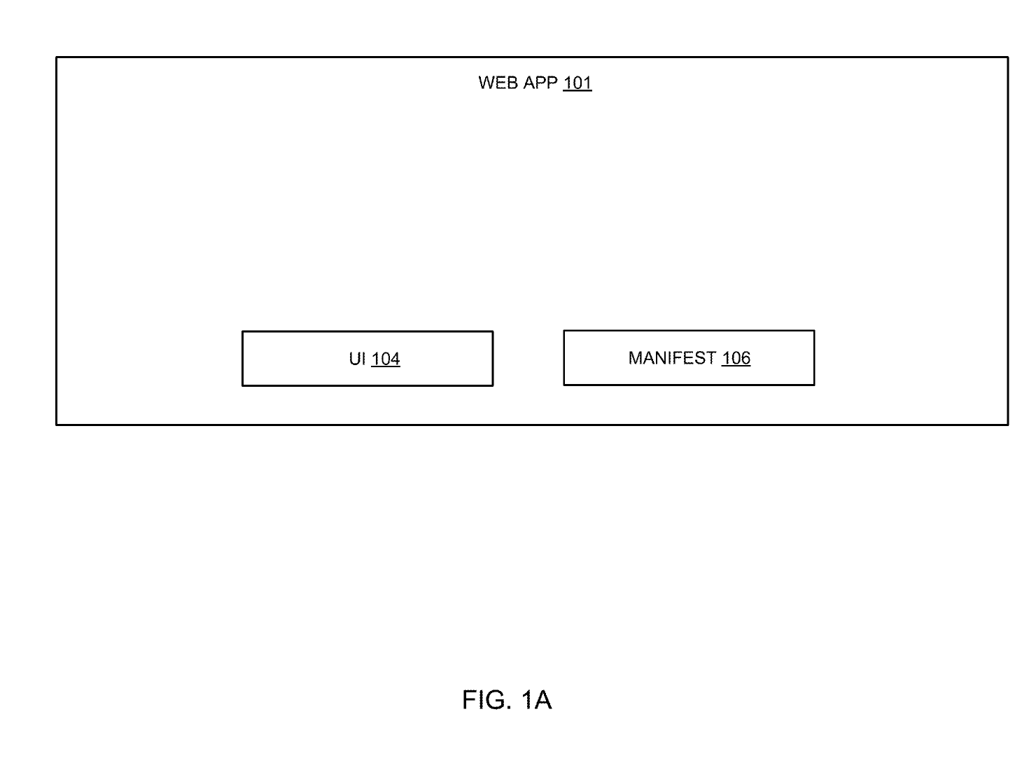

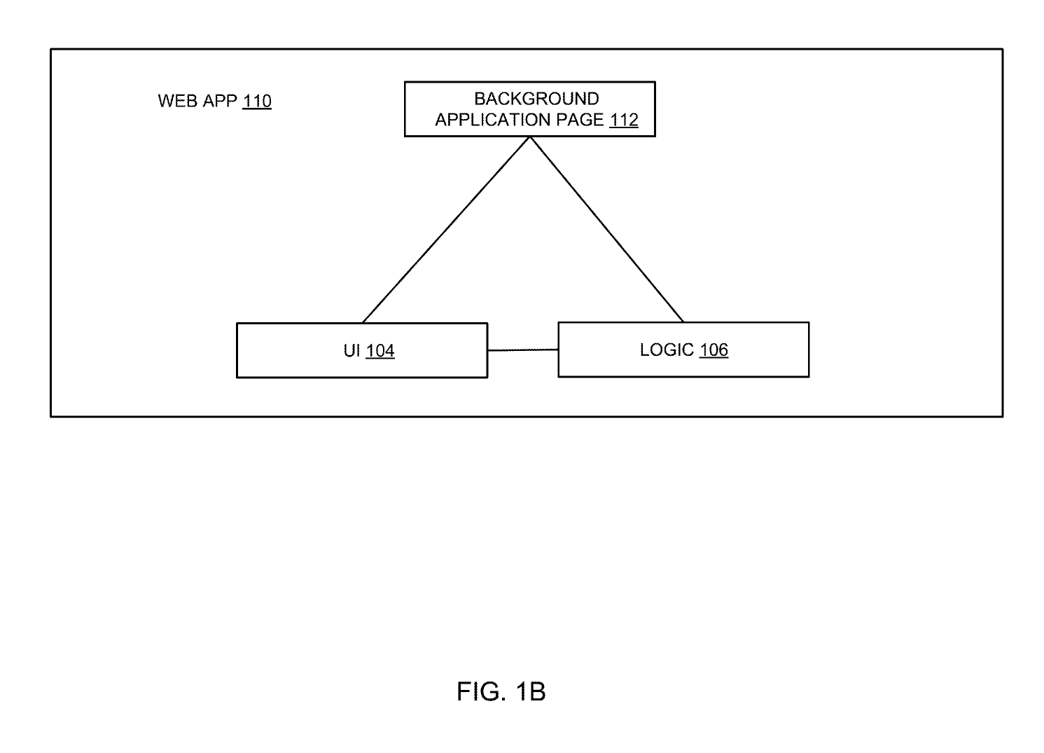

FIG. 1A is an example block diagram of a web application. In this context, a “web application” 101 may be an application that is configured execute a single task or multiple tasks for a user. In such an implementation, the web application may be configured to be executed or interpreted by a web browser. This is compared with the native applications that include machine executable code and are configured to be executed directly by a processor or via the operating system of the client device, whereas, a web application may be incapable of execution or display without the aid of the web browser. Thus, web applications can be run inside a browser with a dedicated user interface, and typically provide functionality and an experience that is more rich and interactive than a standalone website but are less cumbersome and monolithic than a desktop application. Examples of web applications include games, photo editors, and video players that are run inside the browser. A web application may include a manifest file including metadata about the web application (such as a fields for a name, description, version, URLs that the web application uses, icons, permissions, and other data), and one or more web pages or user interface elements.

Throughout this document, a web application, browser extension, or an installed application may refer to a number of different types of applications that are installed in a browser application. Throughout this document, the terms web browser, browser, and browser application may be used interchangeably to mean the same thing.

Web applications can be “hosted applications” or “packaged applications.” Hosted applications may include at least a portion of a web site that itself includes web pages, plus some metadata that may be especially pertinent to the web application or to the user of the web application to allow the web application to perform some particular functionality for the user. Packaged applications can be thought of as web applications whose code is bundled, so that the user can download all of the content of the web application for execution by the browser. A packaged web application may not need to have network access to perform its functionality for the user, and rather may be executed successfully by the browser locally on the computing device without access to a network. Packaged web applications have the option of using Extension APIs, allowing packaged applications to change the way the browser behaves or looks.

In various implementations, a web browser may include or be configured to interact with one or more browser extensions. In this context, a “browser extension” may include one or more web pages packaged or grouped together as a definable whole, and configured to extend the functionality to the web browser. Browser extensions may be webpages and may use all application programming interfaces (APIs) that the browser application provides to web pages. A browser extension may include HTML, CSS, JAVASCRIPT, images, other types of files, and web-related computer languages and code. Thus, browser extensions also provide extra functionality to a browser, but generally, unlike web applications, there is little or no user interface component to the functionality provided by a browser extension. Instead, browser extensions extend the functionality of the browser and the websites being viewed in it. For example, browser extensions can extend the functionality of the browser by adding a new button to the address bar, such as an ever-present currency converter. Buttons like this can also apply to the current website being viewed—for example, clicking the currency converter button can convert all prices on the website presented to a user into a currency chosen by the user. In another example, an extension can be installed so that when a user hovers a cursor over a thumbnail image on a webpage executed by a browser a larger-size version of the image is displayed until the user moves the cursor away from the image. In another example, an extension may be installed to embed a “mail this” button next to every link in every page. Compared to web applications, extensions cut across websites and web applications. Extensions may be in effect across all websites (though some are site-specific). Web applications may not combine with other applications in this way. Rather, web applications generally run standalone, like any regular website.

In the implementation shown in FIG. 1, the web application 101 may be a zipped file (such as a .CRX file) that includes metadata 102 describing the web application, and contains a user interface (UI) element 104, and a manifest 106. UI 104 may include an image file, an HTML file, an icon such as a PNG file, or any other graphical user interface element. Manifest 106 may point to UI 104, and manifest 106 may also include a name, description, version, URL(s), and permissions for the web application, among other data. Manifest may include a URL that the web application uses, including a launch page for the web application, which is a page the browser goes to when a user clicks the web application's icon in a browser. Manifest may be a .JSON or other file format.

In some implementations, natively operating applications (not shown), defined as applications that are coded only with web technologies, such as HTML, CSS, or JAVASCRIPT, may operate like native applications without the use of the browser. Natively operating applications may have a similar structure as web application 101, and may also include background application pages, which are discussed in more detail below with respect to FIG. 1B.

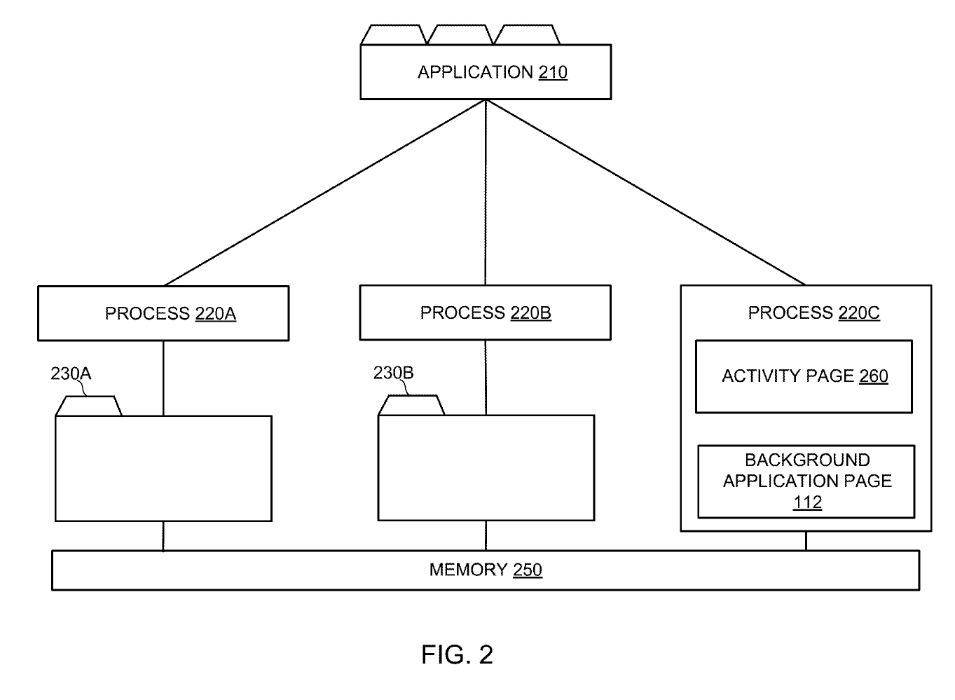

FIG. 1B is an example block diagram of a web application including a background application page architecture. As shown in FIG. 1B, web application 110 includes a background application page 112 (which may be, for example, an HTML file, or JAVASCRIPT file), UI 104, and logic 106. Logic 106 may be included as part of background application page 112. The background application page 112 does not contain any user interface, but instead creates or controls and coordinates the UI 104 and logic 106 for the web app 110. The UI 104 may be contained in other web pages. A background application page 112, as discussed herein, enables a web application or browser extension to run as soon as a user logs into a computer, including before the user launches a web application or browser extension in the browser application. The background application page 112 operates as an invisible element in a browser application. In some implementations, the background application page 112 may continue to run and execute code even when a web application 110, browser extension, and/or the browser application have no visible windows or visible “activity pages”. Activity pages, described in more detail below with respect to FIG. 2, may include any web pages or user interface objects where a user interacts with the web application, and include normal windows, panels, and tray icons. In some implementations, the background application page 112 may be created by a developer of the web application 110, just as a developer may create and include any web page, HTML file, JAVASCRIPT file, image, etc. in web application 110.

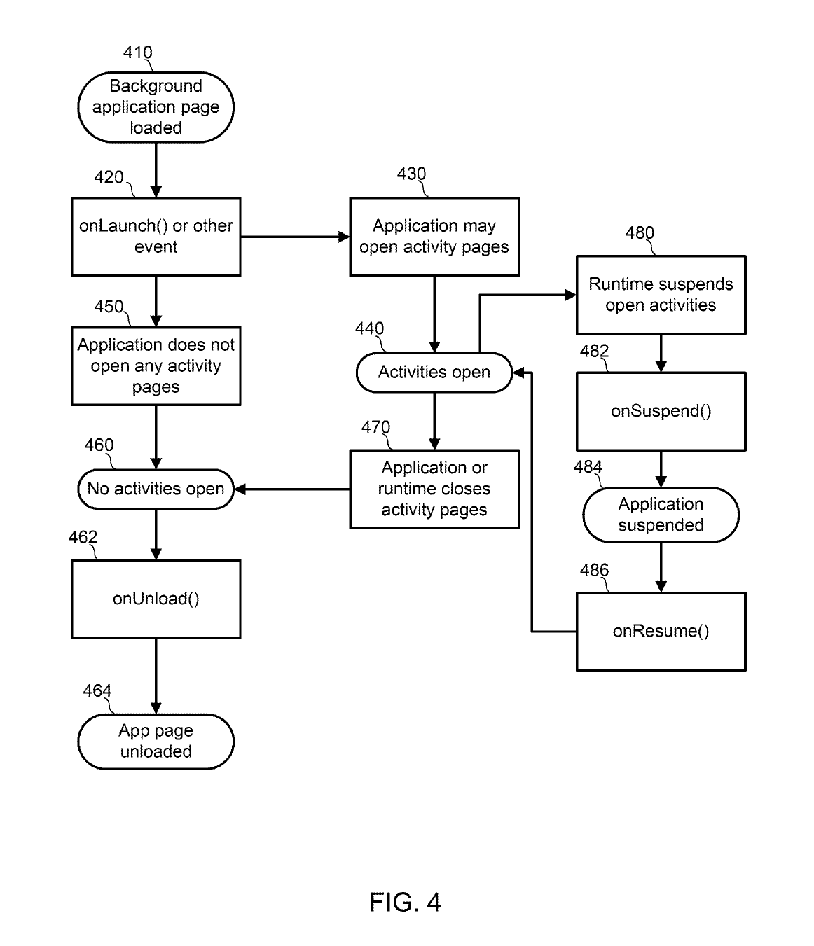

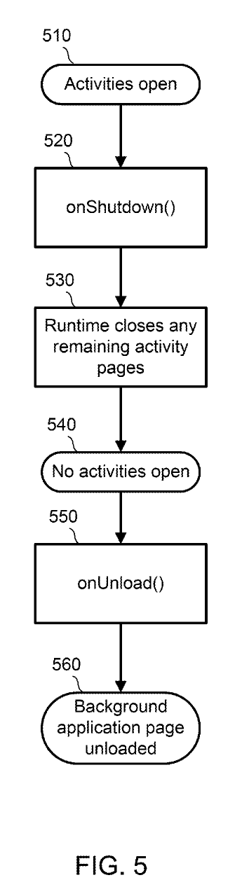

The background application page 112 may operate as a persistent element even when the web application 110 associated with the background application page 112, browser extension, or a browser application is closed. The background application page 112 may not be unloaded while any activity pages are open, although the activity pages themselves could be unloaded by a system automatically, as discussed in more detail below with respect to FIGS. 4 and 5.

Further, the background application page 112 may be launched when a user launches web application 110. When the web application 110 is launched, rather than a web page being opened, the background application page 112 is launched. Background application page 112 has total control of what windows get displayed, how they get displayed, and when they get displayed, and the background application page 112 becomes the hub of handling system level events.

FIG. 2 is a block diagram of a browser that implements a multi-process architecture in accordance with systems and methods described here. In a multi-process system, separate processes may render separate tabs, which may create separate JavaScript threads as well. As shown in FIG. 2, application 210 (which may be, for example, a web browser, a runtime environment, or another application) may execute separate processes 220A, 220B, 220C, which may each display separate tabs (such as 230A and 230B). Tabs 230A and 230B may be separate windows of a web browser, for example, and may each execute separate processes that each have read/write access to at least a portion of a memory 250 of a computing device, each process having its own memory and its own copy of global data structures. One tab (e.g., tab 230A) may be busy while all the other tabs are in use. If there is an error in the renderer of one tab, it may not affect the other tabs, or crash the entire application 210.

In some implementations, a process, such as process 220C, may implement a background application page 112 and one or more activity pages 260 for a web application in the same process. In other implementations, a background application 112 may operate in a separate process from activity page 260. Activity page 260 may include any web pages or user interface objects where a user interacts with a web application associated with the background application page 112, such as normal windows, panels, and tray icons, for example.

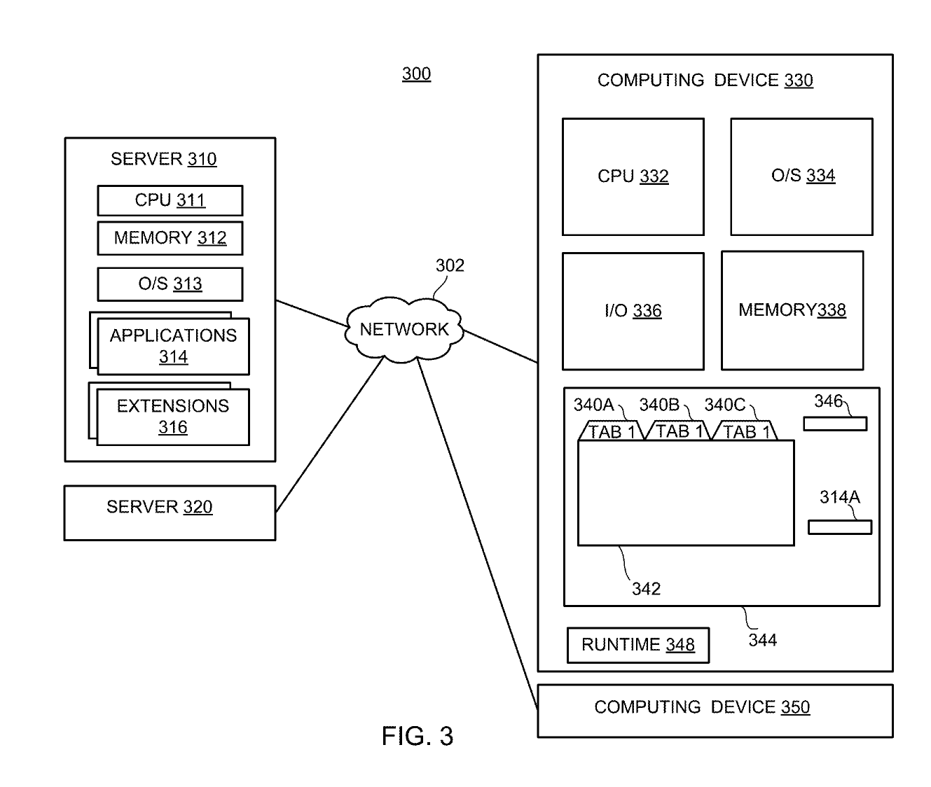

FIG. 3 illustrates a system configured to provide background application pages. System 300 includes servers 310 and 320, operably connected to each other and to computing devices 330 and 350 via a network 302. Network 302 may be any type of network, such as the Internet. Server 310 includes a central processing unit (CPU) 311, memory 312, operating system (O/S) 313, applications 314, and extensions 316. Server 310 may also host various APIs that are asynchronous. Applications 314 may include web applications, and extensions 116 may include browser extensions. The applications 314 and extensions 316 may be provided by developers from various others remote servers, for example, and hosted at server 310.

Computing device 330 includes CPU 332, I/O 336, memory 338, and operating system (O/S) 334, browser application 344, and runtime 348. Runtime 348 may be an environment that is installed at computing device 330, which may provide various services to web applications, web browser extensions, and natively operating applications that are coded with web technology. For example, runtime 348 may manage the install and uninstall of a web application, manage the lifecycle of a web application, send the web application events, and provide a rendering and JAVASCRIPT engine, API implementation, and windowing system for web applications. Runtime 348 may be installed with a browser application 344, or may be installed separately from a web browser, for example with an installation of a web application, or entirely separate of any other installation.

Browser application 344 may include browser application interface 342, including visible tabs 340A, 340B, and 340C, which may each operate in separate processes, as described above with respect to FIG. 2. Browser application 344 may also include a background application page 346 and a web application 314A. As discussed in more detail below, background application page 346 may be executed by browser application 344, along with web application 314A. In some implementations, browser application 344 operating on computing device 330 may also host various APIs that are asynchronous.

In some implementations, a browser lifetime may be kept independent of a web application lifetime. Browser lifetime here refers to a user's impression of a web browser application interface, such as browser application interface 342, and not to the browser process. This means that launching a web application (e.g., web application 314A) may, in some cases, not appear to start the browser application interface 342, and, in some cases, using a menu option to exit the browser application interface 342 may not shut down running applications such as web application 314A. For example, background application page 346 may persist even after a user has exited the browser application interface 342 such that browser application 344 has no visible windows (e.g., browser application interface 342). The background application page 346 may persist, for example until shutdown by the runtime 348.

A lifetime of the background application page 346 may be managed by the runtime 348, as discussed in more detail below with respect to FIGS. 4 and 5. The background application page 346 may be kept alive while any activity pages are open, and as needed to receive events from the runtime 348. Apart from this, the background application page 346 may be unloaded by the runtime 348 at any time.

The runtime 348 may decide when applications such as web application 314A are unloaded, for example to balance system resources with a responsiveness of a web application. In some implementations, the background application page 346 may be notified before being unloaded, and given some predetermined amount of time to save any state, for example via a storage API.

Various examples of installing, unloading, and shutting down applications such as application 314A, background application page 346, and runtime 348 are described in more detail below with respect to FIGS. 4 and 5.

It should be understood that server 320 and computing device 350 may include similar elements as server 310 and/or computing device 330. The use of two servers and two computing devices is merely for illustration, as any number and any configuration of servers, computing devices, and other computers may be used in system 300. For example, an additional sync server and a digital marketplace server may be utilized in system 300.

FIG. 4 is a flow diagram illustrating an application lifecycle, in accordance with systems and methods described here. The lifetime of the background application page may managed by a runtime environment. The background application page may be kept alive while any activity pages are open, and as needed to receive events from the runtime. Otherwise, the background application page may unloaded by the runtime at any time.

Application level events may be hooked by adding listeners to a web browser, for example. As an example, onLaunch(launchData) is called when the application is launched in any way. There is no launch data when the application is started by an application launcher, or by default operating system shortcuts created at application install.

As shown in FIG. 4, a background application page may be loaded (410), for example by an onLaunch( ) or other application level event (420). The background application page may open activity pages (430). For example, the background application page may open a main email program window for an email web application. In such a case, activities are considered open (440). Alternatively, the background application page may not open any activity pages (450), in which case no activities are open (460). If the background application page or the runtime closes all activity pages (470), no activities are open (460). When no activities are open, an on Unload( ) function may be called (462), and the background application page may be unloaded by the runtime (464). Prior to the application page being unloaded, applications may be sent the on Unload event. The application can then save state via a storage API. In some implementations, the runtime may wait for any asynchronous calls to a storage API to complete before unloading the page, but only up to a predetermined time (e.g., 5 seconds.) In some implementations, the runtime may decide, on some platforms, to individually unload activity pages. In this case, the runtime may send events to the windows themselves, instead of to the background application page.

In some implementations, the runtime may suspend all open activities (480), for example using an on Suspend( ) call (482). on Suspend( ) may indicate to the application that the background application page is about to be suspended. This means all events will stop firing and JAVASCRIPT execution will be halted. The background application page may be resumed before being unloaded so there is no need to save state.

The application may be suspended (484), for example until the runtime makes an on Resume( ) call (486), at which point activities are open (440). on Resume( ) indicates to the application that the background application page has just come out of suspension. Events may start firing again, and JAVASCRIPT execution may be resumed.

The runtime decides when applications are unloaded, for example to balance system resources with application responsiveness. In some implementations, the background application page may be notified before being unloaded, and given some time to save any state, for example via a storage API (not shown). As shown in FIG. 4, the application may be guaranteed that the background application page may not be unloaded while activity pages are open, although the activities themselves could, in some implementations, be unloaded by a system automatically.

FIG. 5 is a flow diagram illustrating unloading a background application page, in accordance with systems and methods described here. This can happen when an entire system or device (e.g., device 330 shown in FIG. 3) is being shut down, or when the runtime is being upgraded. When the runtime is being shutdown, the application may be notified (e.g., by the runtime) before any activity pages are closed. If a system (e.g., device 330) is being restarted, the background application page will be loaded again once the system is online and will be sent an event (e.g., on Restart) to signal the application should restore its state. In some implementations, applications which have their background application page loaded but have no activity pages open may not receive the shutdown event, just the unload event. If the restart parameter is true, the runtime is restarting (e.g. to upgrade Chrome). Once it is running again the application will be sent the on Restart event, at which point it can restart all activities in progress to give a seamless restart experience. Therefore, on Restart( ) is sent the app after the app runtime has been restarted, for example to upgrade a runtime or browser. The application may restore its activities to the same state they were in when on Shutdown was received.

As shown in FIG. 5, if activities are open (510), and an on Shutdown( ) event occurs (520), the runtime may close any remaining activity pages (530) such that no activities are open (540). The runtime may call on Unload( ) (550) so that the background application page is unloaded (560).

When the runtime is being shut down or restarted, the application may be sent the on Shutdown( )event (520). The on Shutdown( ) event gives the application the opportunity to signal that the shutdown should be cancelled, and to save application level state. In some implementations, applications may ask for the shutdown be cancelled. An example of where this might apply is if a user is given a prompt to save a document, discard a document being edited, or cancel a shutdown. If an application wishes to cancel a shutdown it may call a cancelShutdown( ) function. If cancelling the shutdown is not allowed, for example if battery of a mobile device is running low, a canCancel parameter will be false. Any calls to cancelShutdown in that situation will be ignored. In some implementations, at shutdown, applications can save state via a storage API. Like the on Load event, the runtime tries to wait for asynchronous calls before proceeding with the shutdown.

In some implementations, applications may prevent their background application pages from unloading, for example using background activity pages, or application runtime API requests. Such tools may make application development simpler and make applications more efficient.

In some implementations, applications may provide web intents. Web Intents is a framework for client-side service discovery and inter-application communication. Services register their intention to be able to handle an action on the user's behalf. Applications request to start an action of a certain verb (such as share, edit, view, pick etc.) and the system will find the appropriate Services for the user to use based on the user's preference. Applications that provide web intents can be launched by web pages or other applications invoking their intent, or by the runtime when applications are launched to view or edit files, for example from an operating system file explorer.

Applications may be able to take parameters. The parameters may be supplied when the application is launched. Such parameters may be used, for example, to allow a related or bundled extension to launch an application with specific launch information, or to allow custom launch types to be added by the application to the application launcher (e.g. for WINDOWS task bar icon, doc icons, launcher, etc.)

In some implemenations, when an application is first installed or when it is upgraded, the application background page may loaded and sent events. The application may then customize launch shortcuts installed in the system or show a welcome page. Applications may be able to register for particular events, including push notifications, API events, and device events (like on NetworkStateChanged and on BatteryLow).

Runtime functions may be exposed by the runtime for applications to use. The APIs for runtime functions may be available to activity pages and to the background application page.

In some implementations an exit( ) event may unload the application. In such implementations, no unload events will be called, and it is up to the application to make sure all necessary state is saved before calling this function.

In some implementations a setAutoLoad(autoLoad) event may be used by the application to declare that it should be loaded automatically when a computing device boots up. This can be used to create tray icon applications, which start when the system is booted, for example.

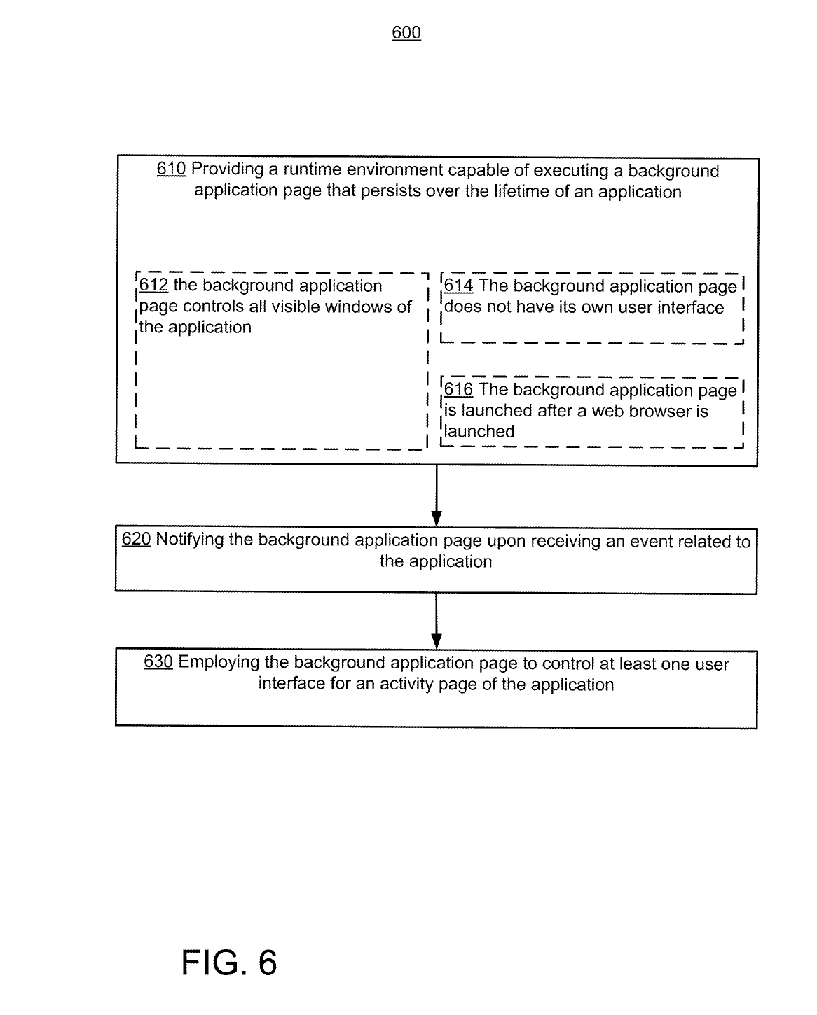

FIG. 6 is an exemplary flow diagram illustrating example operations of the systems described in FIGS. 1-5. The process 600 may be executed at least in part by computing device 330, including background application page 346, and runtime 348, which is shown in FIG. 3. Process 600 may include providing a runtime environment (e.g., runtime 348) capable of executing a background application page (e.g., background application page 346) that persists over the lifetime of an application (610). In some implementations, the background application page controls all visible windows (e.g., activity pages, tabs, icons, etc.) of the application (612). The background application page does not have its own user interface (614). The background application page may be launched after a web browser is launched (616).

The process 600 includes notifying the background application page upon receiving an event related to the application (620). The background application page is employed to control at least one user interface for an activity page of the application (630). For example, the background page may control all email compose, forward, and main windows for an email web application. Because the background application page is utilized as the hub of control for the application, if the main email web application is closed, the compose or forward email windows may still function properly even after the main window is closed. Further, the background application page enables server push notification, so that when a user gets new mail, a server may invoke a function in the background application page to tell the background application page that there is new email. The background application page can, for example, leave the new mail or display a notification, such as a pop up window. The background application page contains logic and data and can make decision without any visible user interface (e.g., mail web application window) being open. Thus, a user does not have to invoke a function to check for new mail or wait for a periodic update while a web application window is open.

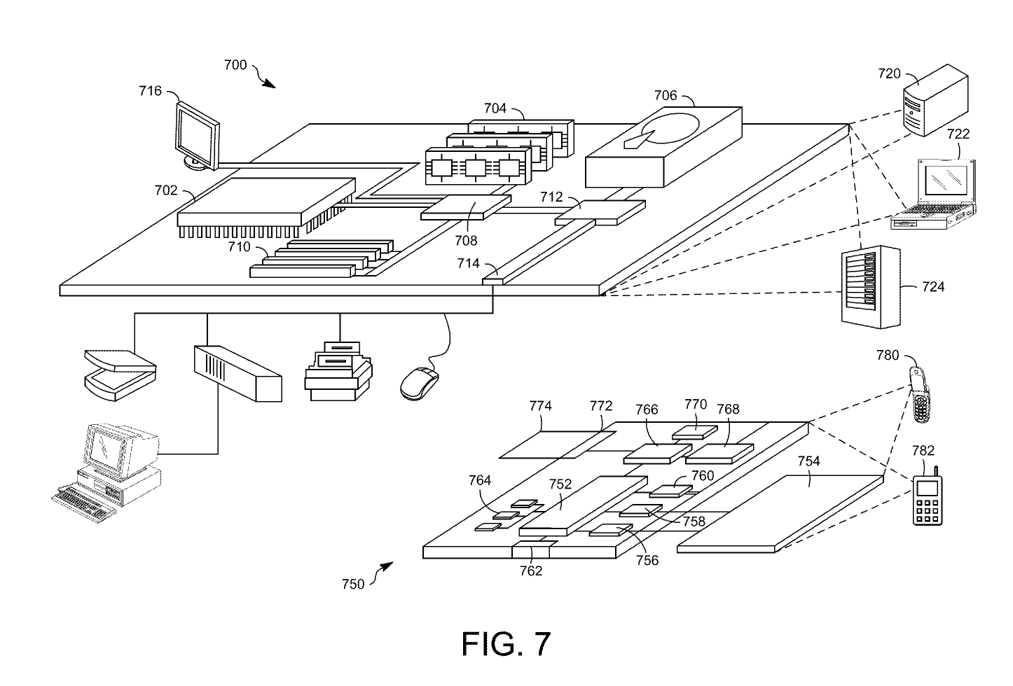

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made to the implementations described herein.

In addition, the logic flows depicted in the figures do not require the particular order shown, or sequential order. In addition, other steps may be provided, or steps may be eliminated, from the described flows, and other components may be added to, or removed from, the described systems. Accordingly, other implementations are within the scope of the following claims.

What is claimed is:

1. A method for background application page implementation, comprising:
providing a runtime environment capable of executing a background application page that persists over a lifetime of a web application, wherein the background application page does not have its own user interface, and the background application page is launched after a web browser is launched;
notifying, using a processor of a computing device, the background application page upon receiving an event related to the web application; and
employing the background application page to control at least one user interface for an activity page of the web application.

2. The method of claim 1, wherein the background application page is programmed using HTML or JavaScript.

3. The method of claim 1, wherein the background application page controls all user interface elements of the web application.

4. The method of claim 1, wherein the background application page controls all logic of the web application.

5. The method of claim 1, further comprising:
displaying a message related to the event after a user has launched the at least one user interface.

6. The method of claim 1, wherein the runtime environment manages an install and an uninstall of the web application on the computing device.

7. The method of claim 1, wherein the runtime environment manages a lifecycle of the web application.

8. The method of claim 1, wherein the web application is a hosted web application for e-mail.

9. The method of claim 1, wherein the event is a user interaction with the at least one user interface.

10. The method of claim 1, further comprising:
sending, by the runtime environment, the event to the background application page.

11. The method of claim 1, wherein the runtime environment provides a rendering engine, a JavaScript engine, an API implementation, and a windowing system.

12. The method of claim 1, further comprising:
collecting information from a server using the background application page.

13. The method of claim 1, further comprising:
receiving the event from a server.

14. A system comprising:
a memory; and
a microprocessor operably connected to the memory and configured to execute code to:
provide a runtime environment capable of executing a background application page that persists over a lifetime of a web application, wherein the background application page does not have its own user interface, the background application page persists after all user interfaces for the web application are closed, and the background application page is launched after a web browser is launched;
notify, using a processor of a computing device, the background application page upon receiving an event related to the web application; and
employ the background application page to control multiple user interfaces for activity pages of the web application.

15. The system of claim 14, wherein the background application page controls all user interface elements of the web application.

16. The system of claim 14, wherein the runtime environment manages an install and an uninstall of the web application on the computing device.

17. The system of claim 14, wherein the runtime environment manages a lifecycle of the web application.

18. The system of claim 14, wherein the web application prevents itself from unloading using the background application page.

19. The system of claim 14, wherein the runtime environment notifies the web application before attempting to unload the web application.

20. A non-transitory computer readable medium containing executable code that causes a computing device to:
provide a runtime environment capable of executing a background application page that persists over a lifetime of a web application, wherein the background application page does not have its own user interface, the background application page persists after all user interfaces for the web application are closed, and the background application page is launched after a web browser is launched;
notify, using a processor of the computing device, the background application page upon receiving an event related to the web application; and
employ the background application page to control multiple user interfaces for activity pages of the web application.
